(19) United States
(12) Patent Application Publication
(10) Pub. No.: US 2026/0126177 A1
(43) Pub. Date: May 7, 2026

(54) SLIDING TV WALL DEVICE WITH FIREPLACE COVER

(71) Applicant: PLANIKA SPÓLKA Z OGRANICZONA ODPOWIEDZIALNOSCIA, Bydgoszcz (PL)

(72) Inventor: Dariusz Krywalski, Solec Kujawski (PL)

(21) Appl. No.: 19/017,654

(22) Filed: Jan. 11, 2025

(30) Foreign Application Priority Data
Nov. 6, 2024 (PL) P.450220

(51) Int. Cl. F24B 1/192; F16M 11/04

(52) U.S. Cl. CPC F24B 1/192; F16M 11/046

(57) ABSTRACT

A sliding TV wall device with a fireplace cover that, when assembled, is to be partially covered with panels, especially with decorative plates and that is intended for use in all kinds of residential and public spaces, is characterized in that it is constructed from two metal columns (1, 2) which are interconnected by transverse arms (3, 4, 14) and between which, in their bottom part, there is a metal shelf (5) which is protruding backwards behind the columns (1, 2) and which has a built-in fireplace (6) and from which, in an upward direction, extends a metal rear plate (7) which adjoins to its rear edge along its entire length, and metal side plates (8) which adjoin to its side edges along their entire length and adjoin to the inner sides of the columns (1, 2), wherein above the shelf (5) with the fireplace (6), at a distance in front of the said metal rear plate (7), there is a middle module (9), which is slidably mounted along the length of the columns (1, 2) in the guides (10) of the columns (1, 2) and which is equipped with a recess open at the front to receive the television receiver and a metal cover (9.3) of the fireplace (6) located at the bottom and wherein the drive of the middle module (9) is located in the columns (1, 2).

### CROSS-REFERENCE TO RELATED APPLICATIONS

This is a non-provisional patent application filed under 35 U.S. C. § 119(a) that claims priority to Polish patent application no.: P.450220, filed Nov. 6, 2024, content of which is incorporated herewith by a reference.

### BACKGROUND

The present invention relates to a sliding TV wall device with a fireplace cover including a fireplace that, when assembled, is to be partially covered with plates, especially with decorative plates and that is intended for use in all kinds of residential and public spaces.

A common practice is to place the fireplace below the television set on the same wall. This makes it necessary to move the television receiver away to a height of about 40-50 cm from the top edge of the fireplace recess, which gives a minimum height of 1.5 m from the ground to the bottom edge of the television receiver, which is an non-ergonomic value for the user.

TV walls with an electric fireplace, built using an oblong, standing cabinet, on which is placed an electric fireplace enclosed behind glass at the front, are known and widely used. Above the fireplace, a rectangular furniture unit with a front-facing open recess is mounted on the wall, housing a television receiver.

TV walls with a fireplace, constructed using steel-profile frameworks clad with decorative plates, are also known. The said walls feature a fireplace incorporated in their lower section, with a television receiver mounted above it in the upper section. Alternatively, the said walls may also be made as masonry walls, for example, with gypsum blocks clad with a decorative plate. In the designs described above, the television receiver is always mounted at a fixed height above the fireplace, and the fireplace, whether lit or not, is always visible to the room's occupant. The said design necessitates positioning the television receiver at a non-ergonomic height of approximately 1.5 meters, resulting in an uncomfortable viewing experience.

U.S. Pat. No. 11,925,266B1 describes a wall bed assembly that includes a bed transformable into a piece of work furniture, such as a desk and a cabinet. The assembly consists of a box-shaped body open at the front, in which the bed, stored in a vertical position, can pivot to a horizontal position. In the lower section of its bottom plate, the bed features either an electric fireplace or a television receiver with a flame display module, above which a folding rectangular plate, serving as the desk top, is mounted and it is adjustable within a 90-degree rotational range. In the interior of the box-shaped body, on its plate adjoining to the mattress of the bed positioned vertically, a television receiver is suspended.

US Patent Application US2023408099A1 discloses a wall in which the fireplace is integrated into the lower part and a television receiver is suspended in the upper part. The fireplace consists of a combustion chamber, a front opening for viewing the interior of the chamber, a rear wall opposite the front opening, and a combustion area located between the front opening and the rear wall. The rear wall can be switched between opaque and transparent states using the controller. The rear wall can be made of a glass panel and may feature a decorative image created using multicolor printing. The print can depict the area behind or near the fireplace.

### BRIEF SUMMARY

When arranging the interior of the rooms, it is desirable for the television receiver and fireplace to be mounted one above the other. This is, of course, due to the fact that the interiors are arranged in such a way that the rest area is centered around the fireplace and the television receiver, which necessitates their direct proximity. Placing a fireplace below a television receiver on one wall requires a 40-50 cm gap between the fireplace and the television receiver. The need to maintain this distance is due to the high temperatures above the fireplace, and the design of the fireplaces and their chimney systems. For the reasons mentioned, the television receiver is mounted at a minimum height of 150 cm from the ground. This height of the television receiver placement is non-ergonomic for the user. It is optimal for the viewer to have the center of the television screen at eye level, which is typically between 90 and 120 cm from the ground.

Since a fireplace is not always a decorative element, a wall design that allows it to be hidden when not in use would be advantageous. Preventing access to the fireplace can also be driven by other factors, such as safety concerns, including childproofing. Prior art technical solutions do not solve this problem.

The installation of a fireplace beneath the television receiver should include a heat dissipation system to ensure that the heat emitted does not affect the television receiver. Since fireplaces are typically installed by general construction workers, rather than specialists in fireplace installation, this aspect is often overlooked. As a result, the television receiver's lifespan is often shortened.

Thus, the problem this invention seeks to solve is to create a design that allows both the fireplace and the television receiver to be mounted on a single wall, with the television receiver positioned at or near the optimal viewing height, while also enabling the fireplace to be covered when not in use.

Another problem this invention seeks to solve is to provide a technical solution that would ensure efficient heat dissipation from the fireplace.

Thus, the goal of the invention is to solve the above problems by creating a robust and easy-to-build TV wall with a fireplace, which can be erected without difficulty by individuals with basic knowledge of the subject.

The sliding TV wall device with a fireplace cover, according to the invention, is characterized in that it is constructed from two metal columns which are interconnected by transverse arms and between which, in their bottom part, there is a metal shelf which is protruding backwards behind the columns and which has a built-in fireplace and from which, in an upward direction, extends a metal rear plate which adjoins to its rear edge along its entire length, and metal side plates which adjoin to its side edges along their entire length and adjoin to the inner sides of the columns, wherein above the shelf with the fireplace, at a distance in front of the said metal rear plate, there is a middle module, which is slidably mounted along the length of the columns in the guides of the columns and which is equipped with a recess open at the front to receive the television receiver and a metal cover of the fireplace located at the bottom and wherein the drive of the middle module is located in the columns.

Preferably, the middle module has an upper position, where the cover included therein, constituting the roof of the fireplace, is positioned above the shelf with the fireplace, at a distance from the lower edge of the cover ranging from 350 mm to 450 mm, and a lower position, where the cover is positioned at the shelf with the fireplace.

Preferably, the drive of the middle module is provided using actuators located in the columns.

Preferably, the middle module is built from a metal rear wall, which adjoins at the bottom to the back edge of the cover in the form of a shelf having a front panel extending from its front edge in a downward direction, and which, at the top, adjoins to the back edge of the roof wall closing the recess formed under it from above and having a front edge adjoining to a front frame extending from it in an upward direction, where the front frame is attached to angle brackets, which are carried through longitudinal cavities formed in the inner corners of the columns, where each of the angle brackets, with its other arm, is attached to the upper section of the side profile, each of which is attached to its respective slider embedded in a guide located in the respective column, and which are connected with longitudinal profiles to which said rear wall is attached.

Preferably, the middle module is all metal.

Preferably, a television receiver mount is fixed in the recess of the middle module.

The design according to the invention, by vertically sliding the middle module, allows the television receiver to be quickly and efficiently positioned at or near the optimal position for the viewer. Bringing the fireplace shelf to the rear behind the columns, installing a sliding middle module in a distance in front of the metal back plate adjoining to the rear edge of the shelf with a fireplace, and providing a front roof for the hearth in the form of a cover allow the warm air flow to be directed to the rear of the device, which is the back of the television receiver. This design protects the television receiver from the heat and ensures its efficient dissipation. In the solution according to the invention, with the middle module in the lower position, the cover covers the fireplace (covers the top surface of the shelf with the fireplace), while with the middle module in the upper position, the cover provides a roof for the fireplace. The solution according to the invention allows the use of fireplaces without additional protection in the form of shelves or deflectors to push back the hot air.

The shiftable middle module has an upper position, in which it creates a recess above the hearth with a height ranging from 350 mm to 450 mm, allowing the fireplace to be used, and a lower position, in which it covers the shelf with a fireplace from the top and front. The structure of the device is entirely made of steel and/or aluminum sections with a thickness ranging from 0.5 mm to 3 mm and steel plates with a thickness ranging from 0.5 mm to 3 mm. The solution according to the invention can use a fireplace fueled by liquid or gas fuel, as well as a steam fireplace or electric fireplace or other heating device. The solution according to the invention allows the television receiver to be positioned with its center at a height of 90-120 cm from the ground, or at a similar distance.

### BRIEF DESCRIPTION OF THE SEVERAL VIEWS OF THE DRAWING

The object of the invention is visualized in the drawings, where

FIG. 1 illustrates an axonometric view of a front side of a device with a middle module in the lower position,

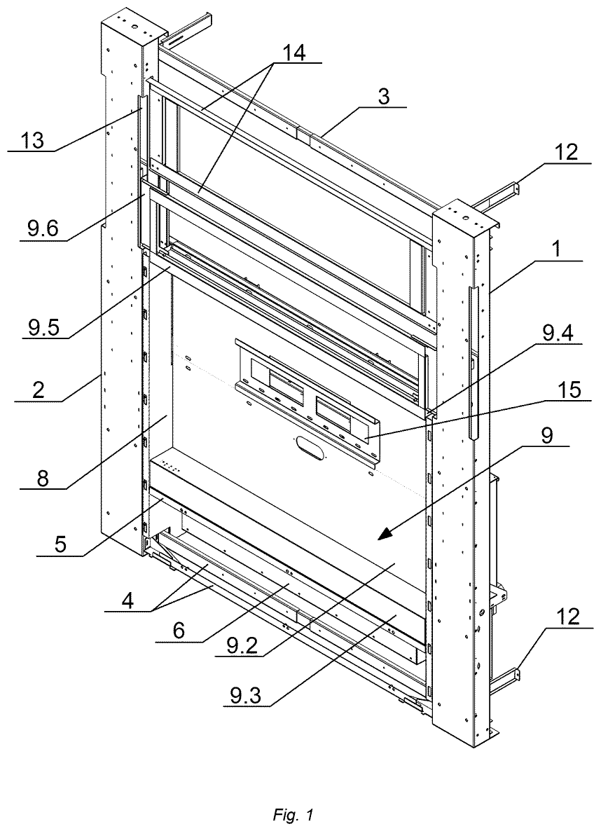

FIG. 2 illustrates an axonometric view of the front side of the device with the middle module in the upper position,

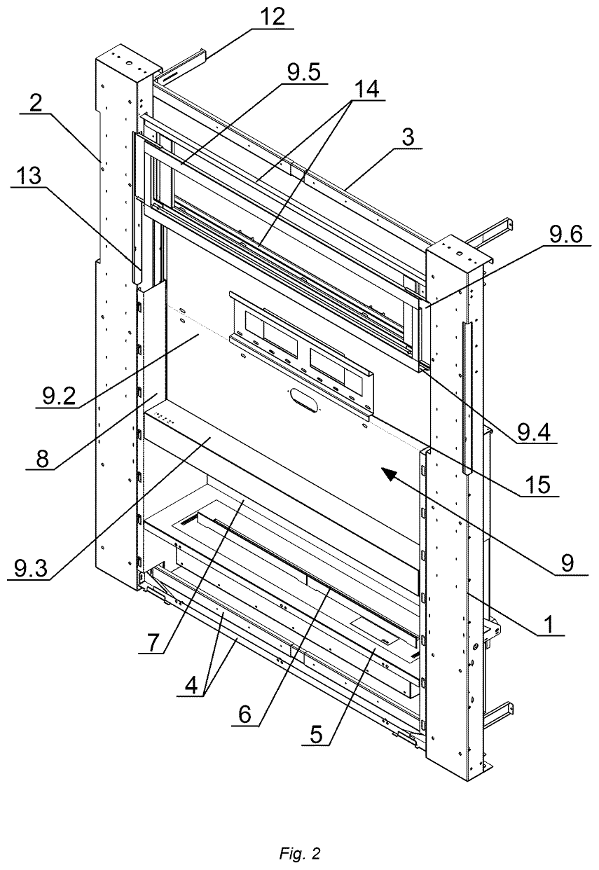

FIG. 3 illustrates an axonometric view of a rear side of the device with the middle module in the lower position,

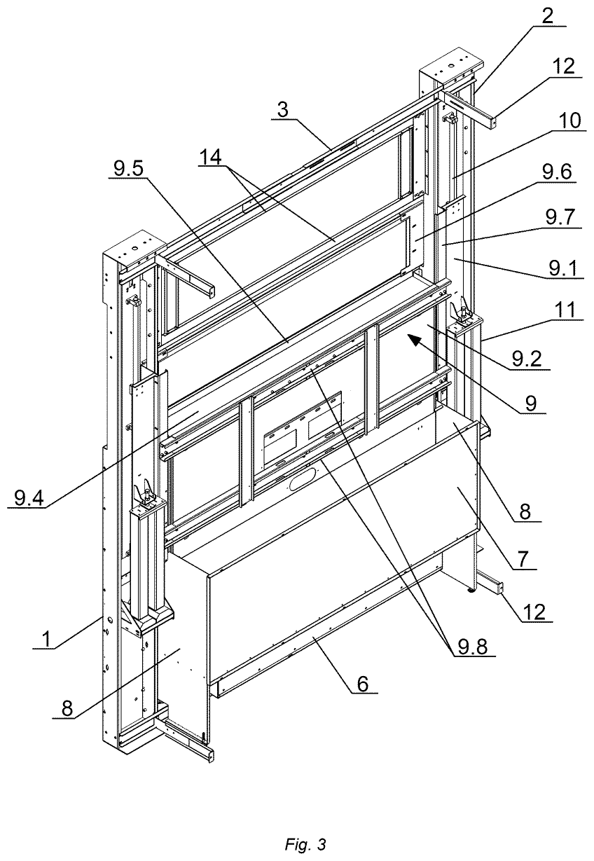

FIG. 4 illustrates an axonometric view of the rear side of the device with the middle module in the upper position,

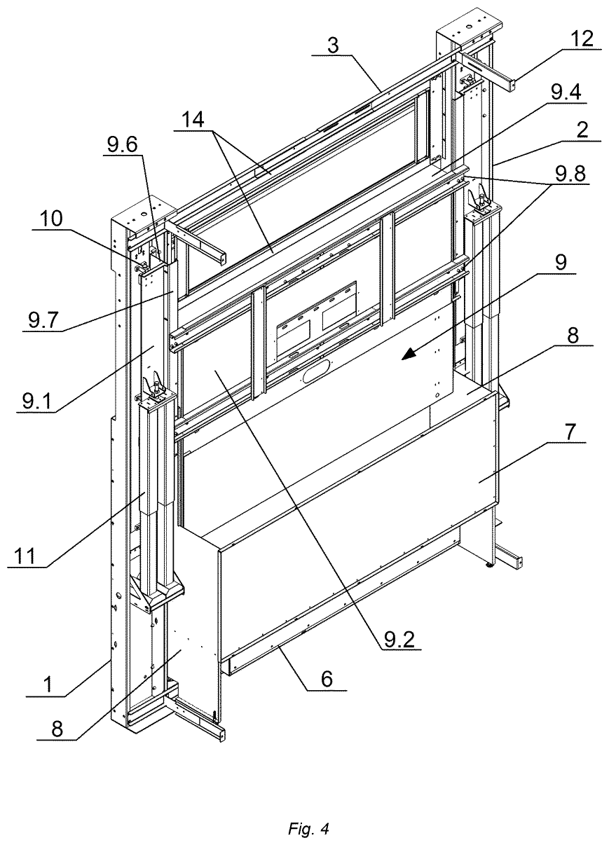

FIG. 5 illustrates a front view of the device with the middle module in the lower position,

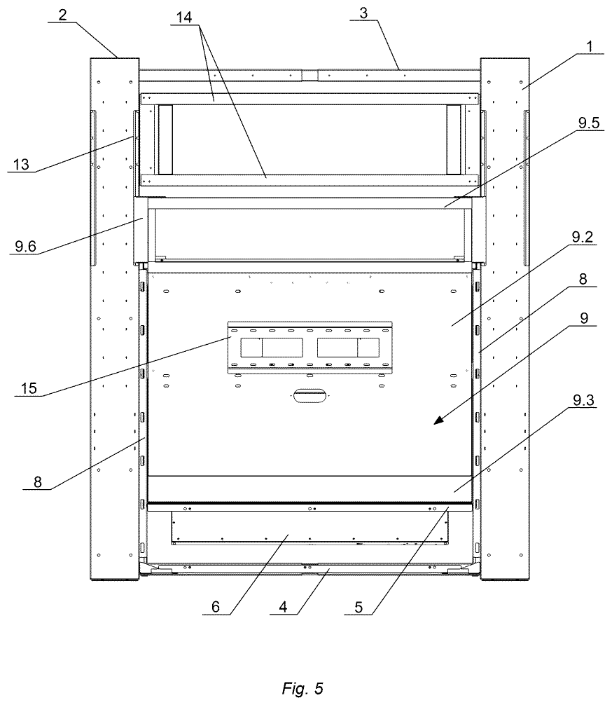

FIG. 6 illustrates a front view of the device with the middle module in the upper position,

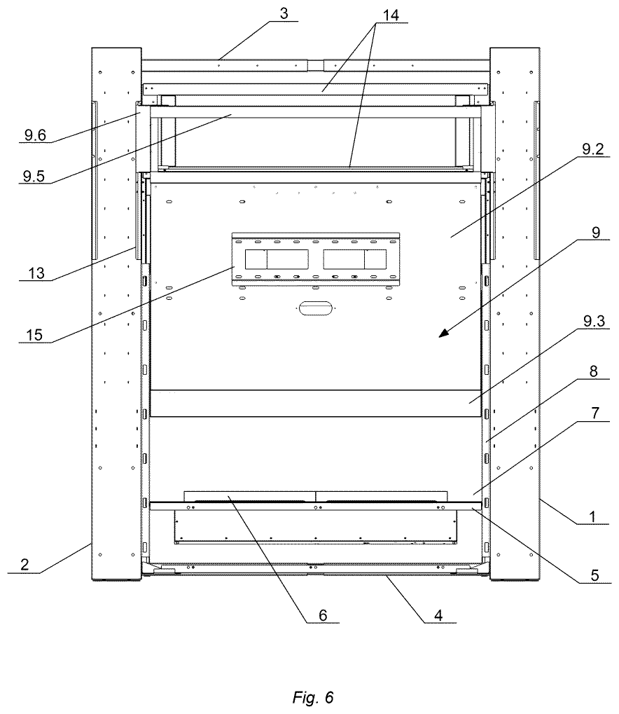

FIG. 7 illustrates a rear view of the device with the middle module in the lower position,

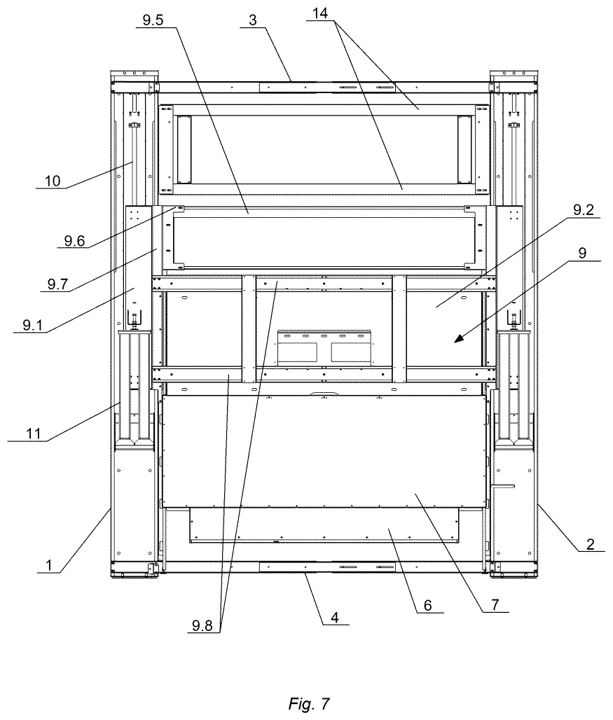

FIG. 8 illustrates a rear view of the device with the middle module in the upper position,

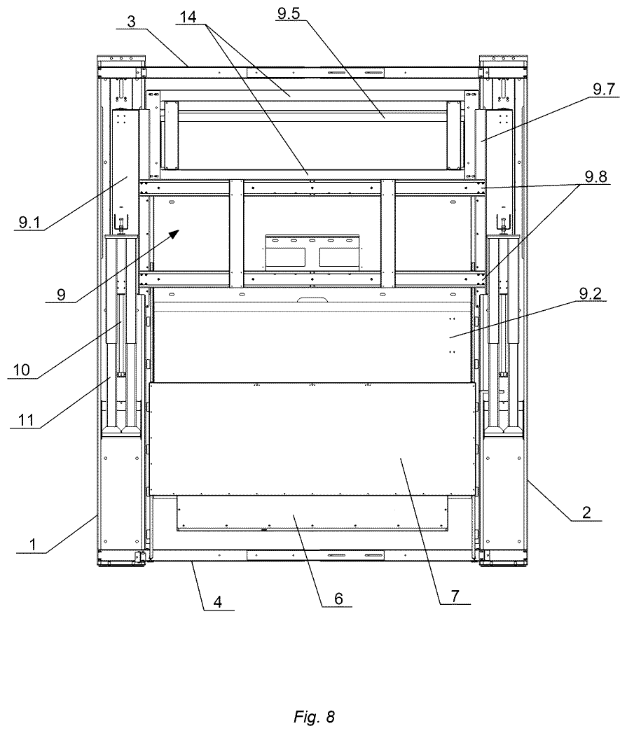

FIG. 9 illustrates an axonometric view of a front side of the middle module,

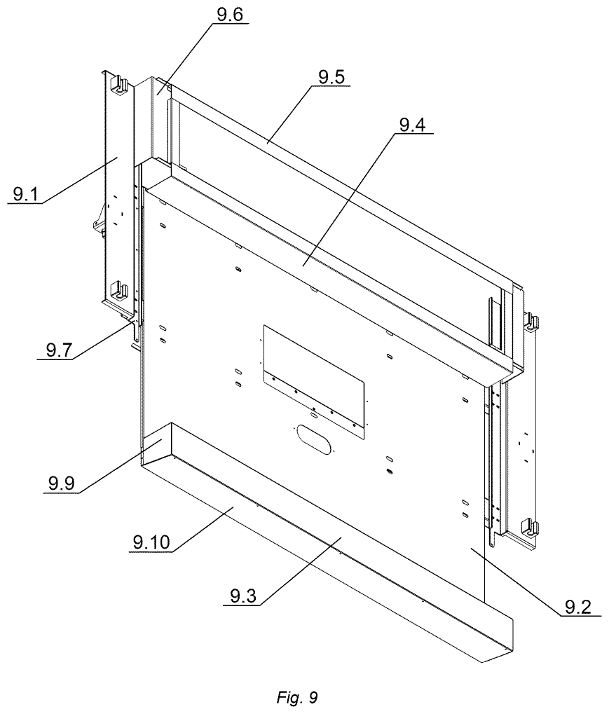

FIG. 10 illustrates an axonometric view of a rear side of the middle module,

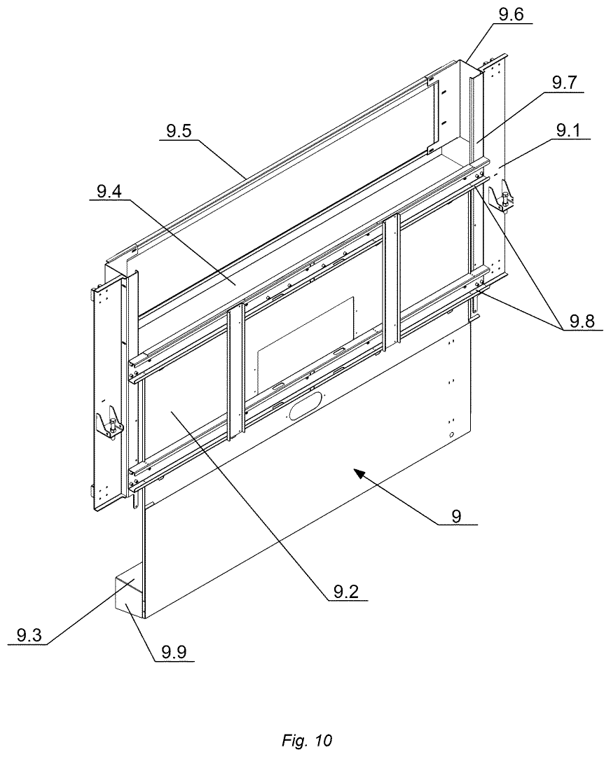

FIG. 11 illustrates an axonometric view of a front side of the device without the middle module,

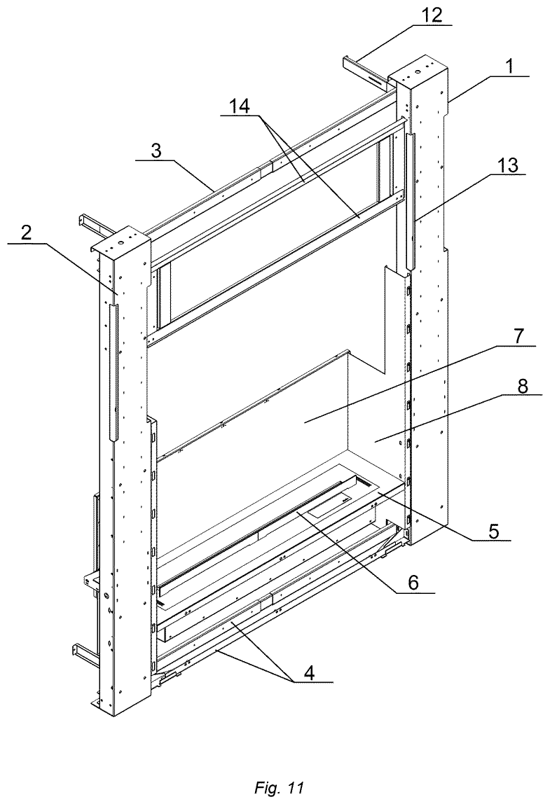

FIG. 12 illustrates an axonometric view of a rear side of the device without the middle module,

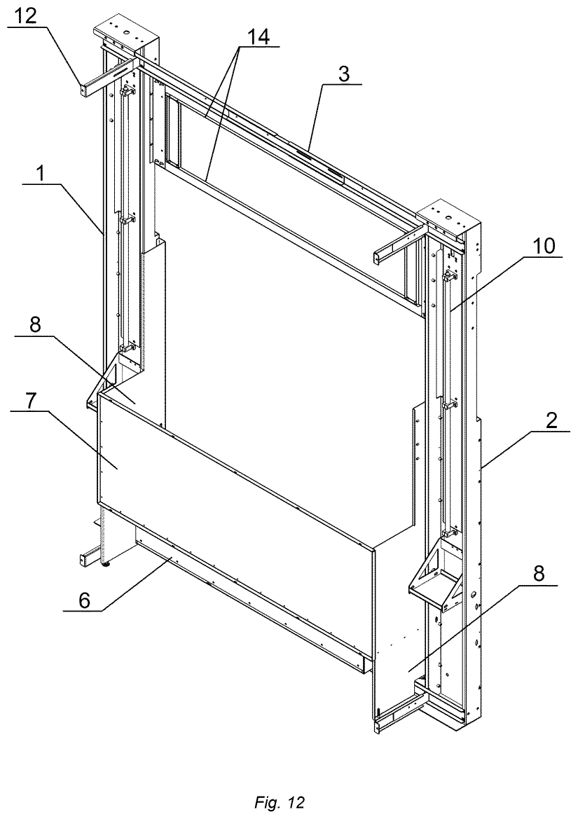

FIG. 13 illustrates an axonometric view of a front side of the device's longitudinal section,

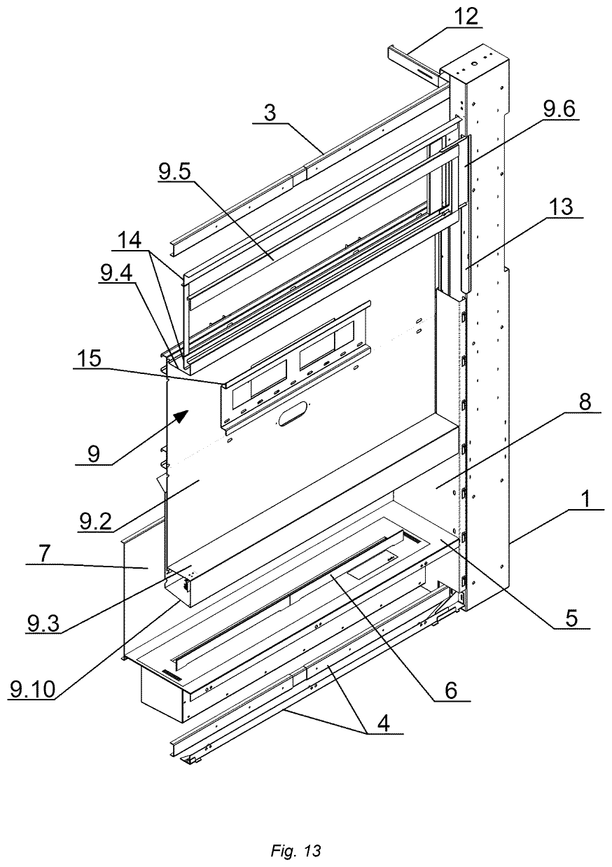

FIG. 14 illustrates an axonometric view of a front side of a device according to the invention, covered with plates, with the middle module in the upper position,

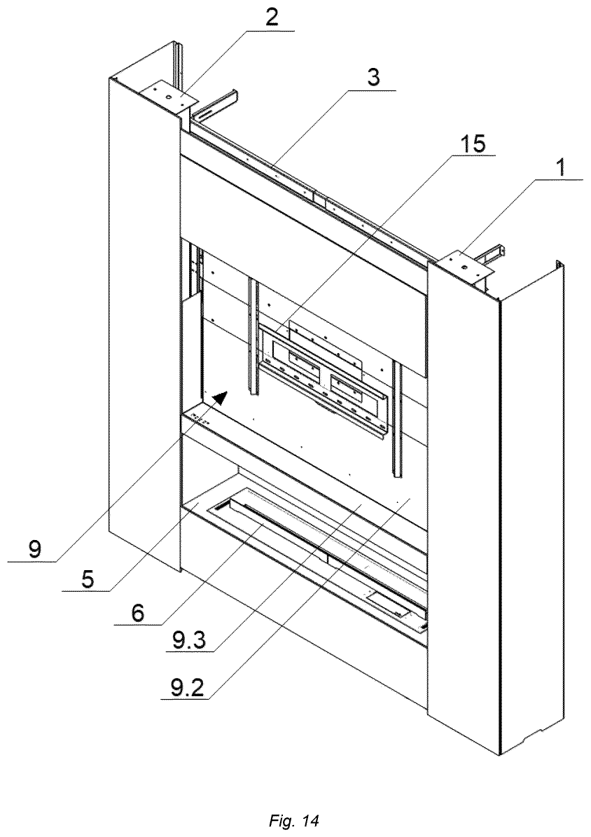

FIG. 15 illustrates an axonometric view of a front side of the device according to the invention, covered with plates, with the middle module in the lower position.

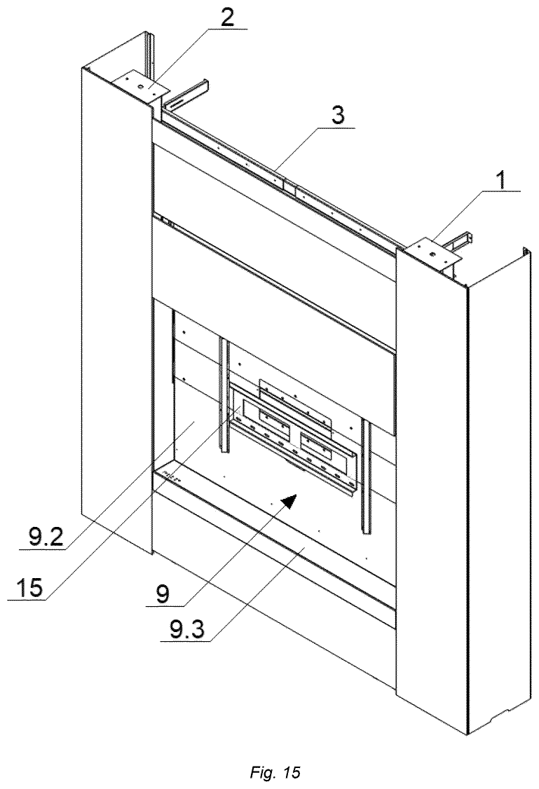

### DETAILED DESCRIPTION OF THE INVENTION

The sliding TV wall device with a fireplace cover in the embodiment according to the invention is formed from two metal columns 1, 2, which at their upper and lower ends are connected with metal transverse arms 3, 4 having adjustable lengths, with a rectangular metal shelf 5, positioned between the columns 1, 2 in their lower part, protruding backward behind the columns 1, 2, into which a fireplace 6 is incorporated, and from which, in an upward direction extend a metal rear plate 7 adjoining to shelf's rear edge along its entire length and metal side plates 8 adjoining to with shelf's side edges along their entire length and permanently adjoining to with the inner sides of the columns, 1, 2. The fireplace 6 in the said shelf 5 is built in such a way that in the plane of the shelf 5 is its hearth and under the shelf 5 is located its remaining body. Located under the shelf 5, the body of the fireplace 6 is covered by a front plate fixed to the structure according to the invention, substantially a decorative plate(s), which is not an object of the invention. Above the shelf 5 with a fireplace 6, between said columns 1, 2 and in front of said metal rear plate 7 adjoining to with the shelf 5 with a fireplace 6, there is positioned a vertically pivotable metal middle module 9, which is slidingly mounted along the length of columns 1, 2 in the vertical guides 10 attached to the columns 1, 2, and which is moved by actuators 11 located in these columns 1, 2, each of which is mounted with its lower end to a foot built into their respective column 1, 2, and with its upper end to their respective slider 9.1 sliding in the guide 10 and comprising part of the middle module 9. The front surface of each of the columns 1, 2 is formed by the web of a steel channel section used to form it. The ends of the said channel sections from the top and bottom are enclosed with a rectangular top and bottom wall, respectively. Each of the columns 1, 2 is equipped with a mounting bracket 12, at both the top and bottom, with an adjustable length, extending backwards. The middle module 9 has a width equal to the spacing dimension of the columns 1, 2. Each of the guides 10 of the pivotable middle module 9 is in the form of a circular rod installed in a handle that is fixed in the rear of the column 1, 2. Said middle module 9, embedded between the columns 1, 2, in addition to the above-mentioned sliders 9.1 mounted slidingly in their respective guides 10, where each of the sliders 9.1 is in the form of a flat parallel to the front wall of the column 1, 2, which is equipped with clamps slidingly embedded on the guide 10, also comprises a rectangular metal rear wall 9.2, which adjoins at the bottom to a cover 9.3 (of the fireplace 6) in the form of a rectangular metal shelf having a rectangular front panel extending from its front edge in a downward direction at right angles. Said shelf, which provides the cover 9.3 of the fireplace 6, together with the rear wall 9.2, with middle module 9 in the lower position, covers the shelf 5 with the fireplace 6 at the front and top, and more precisely covers the hearth of the fireplace 6 and the entire top surface of the shelf 5. At the top, said metal rear wall 9.2 adjoins to the rear edge of the roof wall 9.4, which, positioned with respect to the rear wall 9.2 at right angles, encloses from above, over the entire width of the central module 9, the recess formed underneath, to receive the television receiver, and whose front edge adjoins to the front frame 9.5 extending therefrom at right angles in an upward direction, which is positioned in the front surface of the device and which is attached to the angle brackets 9.6 carried through the longitudinal cavities 13 formed in the inner corners of the columns 1, 2, where each of the angle brackets 9.6, with its other arm, is attached to the upper section of the side profile 9.7, which is along its entire length attached to its respective middle module 9 slider 9.1 embedded in the guide 10. Said side profiles 9.7 of the middle module 9 are interconnected with transverse profiles 9.8 mounted to them, which link with the aforementioned rear wall 9.2 of the middle module 9. At the bottom, the middle module 9 with a metal rear plate 7 extending upwards from the shelf 5 with the fireplace 6 adjoins to its rear wall 9.2, which is positioned at a distance ranging from 150 mm to 250 mm in respect to said metal rear plate 7. Said longitudinal cavities 13, formed in the inner corners of each of the columns 1, 2, are of a length that allows to lower the front frame 9.5 and, therefore, the entire middle module 9 to a position at which the hearth of the fireplace 6 is covered and which also allows to raise the front frame 9.5 and therefore the entire middle module 9 to a position at which the distance between the cover 9.3 of the fireplace 6 and the shelf 5 with the fireplace 6 forms an opening (recess) that allows the use of the fireplace 6, while also providing an attractive flame appearance and safety. In addition, between the columns 1, 2, in their upper part, behind said front frame 9.5 of the middle module 9, there are transverse arms 14 attached to the columns 1, 2 and interconnected by vertical arms, which are intended for attaching to them plate components, substantially, decorative components, which, in the lower position of the middle module 9, cover the recess formed in the upper part of the device between the columns 1, 2, which is not covered with anything else. The above-mentioned plate components are not the object of the invention. The rear wall 9.2, which is part of the sliding middle module 9, is located, in respect to the shelf 5 with the fireplace 6 below it, in the area of the center of its depth. Thus, the depth of said cover 9.3 depends on the depth of embedment of the rear wall 9.2 of the middle module 9. The side, horizontal and vertical, edges of the shelf forming the cover 9.3 of the fireplace 6 adjoin to the side walls 9.9 reinforcing its rigidity. In addition, said shelf (the shelf forming the cover 9.3) from the bottom adjoins to the bottom plate 9.10, which, extending from the bottom edge of its front panel, run diagonally upward past its rear edge, beyond which it runs parallel and in a distance to the middle module 9 plate along with which it forms the rear wall 9.2 of the middle module 9, more particularly its lower part. Located above the shelf 5 with the fireplace 6, the side plates 8 are also located under the shelf 5 with the fireplace 6. Under the shelf 5, they provide supporting structures (legs set on the ground), which are set on feet with an adjustable height. While, in the part above the shelf 5 with the fireplace 6, the side plates 8 run to the lower edges of the longitudinal cavities 13 of the inner corners of the columns 1, 2, while in the upper part, that is, in their area that is situated above the cover 9.3 of the fireplace 6, when it is in its upper position, they are less than half of their width, due to the fact that the deeper interior of the structure is obscured by the rear wall 9.2 of the middle module 9 located in the middle area of the depth of the shelf 5 with the fireplace 6. A television receiver mount 15 is attached to the middle module 9 rear wall 9.2, which forms a recess for the television receiver. The middle module 9 has an upper position, where the cover 9.3 included therein, constituting the roof of the fireplace 6, is positioned above the shelf 5 with the fireplace 6, at a distance from the lower edge of the cover 9.3 ranging from 350 mm to 450 mm, and a lower position, where the cover 9.3 is positioned at the shelf 5 with the fireplace 6. The solution herein disclosed according to the invention is meant to be encased with tiles or plates, especially decorative tiles or plates made of stone, concrete, gypsum ceramic or other materials. Said plates or tiles are, generally, attached to this structure, to covering the front and side surfaces of the columns 1, 2, the space under the shelf 5 with the fireplace 6, the space between the transverse arms 14 located behind the front frame 9.5 when it is in its upper position, the area of the front frame 9.5 and the area of the front panel of the shelf constituting the cover 9.3 of the fireplace 6 hearth. The middle module 9 as well as the remaining part of the device according to the invention are all metal. Said plates can be attached to this structure with commercially available adhesives. The device according to the invention can be assembled in the order as described as follows: the columns 1, 2 are set up, then they are connected using the transverse arms 3, 4, 14, and the shelf 5 with the fireplace 6 is mounted between them, along with its respective side plates 8 and rear plate 7, then to the columns 1, 2 the middle module 9 support structure is mounted, which consists of sliders 9.1 with side profiles 9.7 and angle brackets 9.6 of the front frame 9.5, and the transverse profiles 9.8 bolted to them. Subsequently, the plate structure of the middle module 9 and its front frame 9.5 are attached to the supporting structure with screws, bolts or other types of connections. In the meantime, the remaining unmentioned components are assembled. Subsequently, the entire unit, after leveling, is mounted to the wall using mounting brackets 12 with an adjustable length attached to the columns 1, 2. The finished device is provided with middle module 9 position sensors, a fireplace ignition sensor, an actuator controller, and encased in decorative plates. Generally, the entire device is made of metal, either steel or aluminum. The device according to the invention can be manufactured in a number of different sizes, generally depending on the size of the television receiver and the height of the room. For example, for a 75-inch television receiver, the shelf 5 with the fire place 6 can be placed at a height of about 400 mm from the ground, can be about 1725 mm long and up to 450 mm deep. The hearth cavity can be 350 mm to 450 mm high, depending on the height of the room. The height of columns 1, 2, depending on the height of the room, can generally be from 2700 mm and higher, and their width can be, for example, 200 mm. The depth of the recess to receive the television receiver depends on the model of the mount and the thickness of the television receiver. Generally, the television receiver should be flush with the plates enclosing the device according to the invention. The device is generally placed at a minimum distance of 450 mm from the wall. The solution according to the invention is in no way limited to the above-mentioned example of device dimensions. In this device, the fireplace 6 can be a liquid or gas-fueled fireplace, as well as a steam fireplace, electric fireplace or other such heating device.

1. A sliding TV wall device with a fireplace cover, characterized in that it is constructed from two metal columns (1, 2) which are interconnected by transverse arms (3, 4, 14) and between which, in their bottom part, there is a metal shelf (5) which is protruding backwards behind the columns (1, 2) and which has a built-in fireplace (6) and from which, in an upward direction, extends a metal rear plate (7) which adjoins to its rear edge along its entire length, and metal side plates (8) which adjoin to its side edges along their entire length and adjoin to the inner sides of the columns (1, 2), wherein above the shelf (5) with the fireplace (6), at a distance in front of the said metal rear plate (7), there is a middle module (9), which is slidably mounted along the length of the columns (1, 2) in the guides (10) of the columns (1, 2) and which is equipped with a recess open at the front to receive the television receiver and a metal cover (9.3) of the fireplace (6) located at the bottom and wherein the drive of the middle module (9) is located in the columns (1, 2).

2. Device according to claim 1, characterized in that middle module (9) has an upper position, where the cover (9.3) included therein, constituting the roof of the fireplace (6), is positioned above the shelf (5) with the fireplace (6), at a distance ranging from 350 mm to 450 mm, and a lower position, where the cover (9.3) is positioned at the shelf (5) with the fireplace (6).

3. Device according to claim 1, characterized in that the drive of the middle module (9) is provided by actuators (11) located in the columns (1, 2).

4. Device according claim 1, characterized in that the middle module (9) is built from a metal rear wall (9.2), which adjoins at the bottom to the back edge of the cover (9.3) in the form of a shelf having a front panel extending from its front edge in a downward direction, and which, at the top, adjoins to the back edge of the roof wall (9.4) closing the recess formed under it from above and having a front edge adjoining to a front frame (9.5) extending from it in an upward direction, where the front frame (9.5) is attached to angle brackets (9.6), each of which is carried through its respective longitudinal cavities (13) formed in the inner corners of the columns (1, 2), where each of the angle brackets (9.6), with its other arm, is attached to the upper section of its respective side profile (9.7), each of which is attached to the slider (9.1) embedded in the guide (10) located in its respective column (1, 2), and which are connected with longitudinal profiles (9.8) to which said rear wall (9.2) is attached.

5. Device according to claim 1, characterized in that the middle module (9) is all metal.

6. Device according to claim 1, characterized in that a television receiver mount (15) is fixed in the recess of the middle module (9).
